(19) United States
(12) Patent Application Publication
(10) Pub. No.: US 2022/0350210 A1
(43) Pub. Date: Nov. 3, 2022

(54) DISPLAY PANEL AND DISPLAY DEVICE

(71) Applicant: SHENZHEN CHINA STAR OPTOELECTRONICS SEMNICONDUCTOR DISPLAY TECHNOLOGY CO., LTD, Shenzhen (CN)

(72) Inventors: Yang LIU, Shenzhen (CN); Peng DU, Shenzhen (CN); Jianhong CHEN, Shenzhen (CN); Jianjian YING, Shenzhen (CN); Yue WANG, Shenzhen (CN)

(21) Appl. No.: 17/600,494

(22) PCT Filed: Dec. 30, 2020
(86) PCT No.: PCT/CN2020/141193

§ 371 Date: Sep. 30, 2021

(30) Foreign Application Priority Data
Dec. 1, 2020 (CN) 202011386094.2

(51) Int. Cl. G02F 1/1362

(52) U.S. Cl. CPC G02F 1/136286; G02F 1/136222

(57) ABSTRACT

A display panel and a display device are provided. The display panel includes a common electrode layer, a power management chip, and a time schedule controller. By configuring the common electrode layer into a plurality of common electrode partitions, and by adjusting a feedthrough voltage according to a feedback voltage of each of the common electrode partitions, a DC voltage in each of the common electrode partitions can be maintained as a better value, thereby weakening or eliminating a problem of image sticking.

### BACKGROUND OF INVENTION

### Field of Invention

The present application relates to a field of display technology, particularly to a field of liquid crystal display technology, and specifically to a display panel and a display device.

### Description of Prior Art

When a liquid crystal display device displays a same image for a long time, and then switches the current image to a next image, the current image remains in the next image. This phenomenon is named as image sticking (IS), image persistence, burn marks, etc. Existence of the IS can greatly affect display quality and effect, causing poor customer experience, loss of production yield, and resulting in reduction of market acceptance of display panels.

The IS is one of long-standing and stubborn issues of liquid crystal displays (LCDs), and many factors are involved. If this problem occurs, troubleshooting and resolution are time-consuming and laborious, which seriously affects production and cross-border procedure of the panels.

In traditional technical solutions, designs of an whole-surface form and a same signal are mostly adopted in common electrode layers of color filter substrates in liquid crystal displays, and a DC voltage inputted into the common electrode layers remains, which causes electric potential drift of the actual DC voltage in the common electrode layers, and then leading to occurrence of the IS.

### SUMMARY OF INVENTION

Present application provides a display panel and a display device, which solve a problem of image sticking due to drift incurred by a DC voltage of the whole-surface common electrode layer.

On a first aspect, the present application provides a display panel, which includes a common electrode layer, a power management chip, and a time schedule controller. The common electrode layer is configured as N common electrode partitions electrically isolated from each other. The power management chip is electrically connected to the common electrode partitions and is configured to provide a feedthrough voltage to the common electrode partitions according to a control signal. The time schedule controller is electrically connected to the common electrode partitions and the power management chip, and outputs a corresponding control signal in response to a feedback voltage of the common electrode partitions being out of an offset range. Wherein, N is an integer greater than or equal to 2.

On the basis of the first aspect, in a first embodiment of the first aspect, the N common electrode partitions electrically isolated from each other are distributed in a matrix manner.

On the basis of the first embodiment of the first aspect, in a second embodiment of the first aspect, at least one row or at least one column of the common electrode partitions have same areas and are rectangular.

On the basis of the second embodiment of the first aspect, in a third embodiment of the first aspect, a length direction of the common electrode partitions is consistent with a width direction of the display panel, and a width direction of the common electrode partitions is consistent with a length direction of the display panel.

On the basis of the first aspect, in a fourth embodiment of the first aspect, the time schedule controller responds to a first offset value of the feedback voltage, and the power management chip outputs the feedthrough voltage added by a second offset value, and wherein the first offset value and the second offset value are opposite to each other.

On the basis of the first aspect, in a fifth embodiment of the first aspect, the display panel includes a color film substrate, and the common electrode layer is disposed on the color film substrate.

On the basis of the fifth embodiment of the first aspect, in a sixth embodiment of the first aspect, the display panel further includes an array substrate, and the array substrate is aligned with the color film substrate to form a cell by sealant, and wherein conductive gold particles are disposed in the sealant.

On the basis of the sixth embodiment of the first aspect, in a seventh embodiment of the first aspect, the display panel further includes a chip-on-film thin film and a first conductive layer disposed on the array substrate, a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.

On a second aspect, the present application provides a display panel. A common electrode layer is disposed in the display panel. The common electrode layer includes N common electrode partitions electrically isolated from each other. The display panel outputs a corresponding feedthrough voltage to the common electrode partitions in response to a feedback voltage of the common electrode partitions being out of an offset range. Wherein, the common electrode partitions are circular or elliptical.

On the basis of the second aspect, in a first embodiment of the second aspect, the display panel further includes a color film substrate, and the common electrode layer is disposed on the color film substrate.

On the basis of the first embodiment of the second aspect, in a second embodiment of the second aspect, the display panel further includes an array substrate, and the array substrate is aligned with the color film substrate to form a cell by sealant, and wherein conductive gold particles are disposed in the sealant.

On the basis of the second embodiment of the second aspect, in a third embodiment of the second aspect, the display panel further includes a chip-on-film thin film and a first conductive layer disposed on the array substrate, a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.

On a third aspect, the present application provides a display device, including the display panel of any of the aforesaid embodiments. Wherein, the time schedule controller responds to a first offset value of the feedback voltage, the power management chip outputs the feedthrough voltage added by a second offset value, and wherein the first offset value and the second offset value are opposite to each other.

On the basis of the third aspect, in a first embodiment of the third aspect, the N common electrode partitions electrically isolated from each other are distributed in a matrix manner.

On the basis of the first embodiment of the third aspect, in a second embodiment of the third aspect, at least one row or at least one column of the common electrode partitions have same areas and are rectangular.

On the basis of the second embodiment of the third aspect, in a third embodiment of the third aspect, a length direction of the common electrode partitions is consistent with a width direction of the display panel, and a width direction of the common electrode partitions is consistent with a length direction of the display panel.

On the basis of the third aspect, in a fourth embodiment of the third aspect, the display panel further includes a color film substrate, and the common electrode layer is disposed on the color film substrate.

On the basis of the fourth embodiment of the third aspect, in a fifth embodiment of the third aspect, the display panel further includes an array substrate, and the array substrate is aligned with the color film substrate to form a cell by sealant, and wherein conductive gold particles are disposed in the sealant.

On the basis of the fifth embodiment of the third aspect, in a sixth embodiment of the third aspect, the display panel further includes a chip-on-film thin film and a first conductive layer disposed on the array substrate, a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.

In the display panel and the display device provided by the present application, by configuring the common electrode layer into the plurality of common electrode partitions, and by adjusting the feedthrough voltage according to the feedback voltage of each of the common electrode partitions, the DC voltage in each of the common electrode partitions can be maintained in a better value, thereby weakening or eliminating the problem of image sticking.

### DESCRIPTION OF DRAWINGS

FIG. 1 is a structural schematic diagram of a common electrode layer provided by one embodiment of the present application.

FIG. 2 is a structural schematic diagram of a display panel provided by one embodiment of the present application.

FIG. 3 is a structural schematic diagram of a chip-on-film thin film and wiring between fan-out routes in the display panel provided by one embodiment of the present application.

FIG. 4 is a partially enlarged schematic diagram illustrated in FIG. 3.

FIG. 5 is a structural schematic diagram of a wiring strapping to a feedthrough wiring and a feedback wiring between a first conductive layer and a second conductive layer provided by one embodiment of the present application.

FIG. 6 is a structural schematic diagram during the feedthrough wiring and the feedback wiring strapping to a color film substrate through a transfer pad provided by one embodiment of the present application.

FIG. 7 is a structural schematic diagram of a display device provided by one embodiment of the present application.

### DETAILED DESCRIPTION OF PREFERRED EMBODIMENTS

For making the purposes, technical solutions and effects of the present disclosure be clearer and more definite, the present disclosure will be further described in detail below. It should be understood that the specific embodiments described herein are merely for explaining the present disclosure and are not intended to limit the present disclosure.

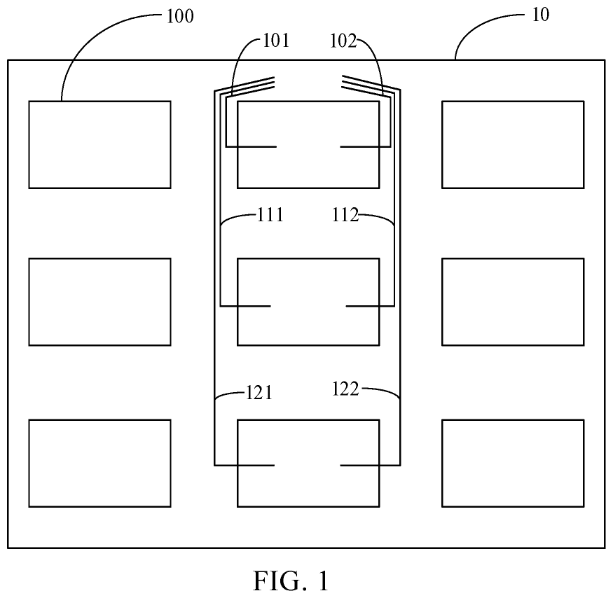

Please refer to FIG. 1 to FIG. 7, this embodiment provides a first aspect. The present application provides a display panel 1100. The display panel 1100 includes a color film substrate and an array substrate. The array substrate is aligned with the color film substrate to form a cell by sealant. Wherein, conductive gold particles are disposed in the sealant. The common electrode layer 10 is disposed on the color film substrate.

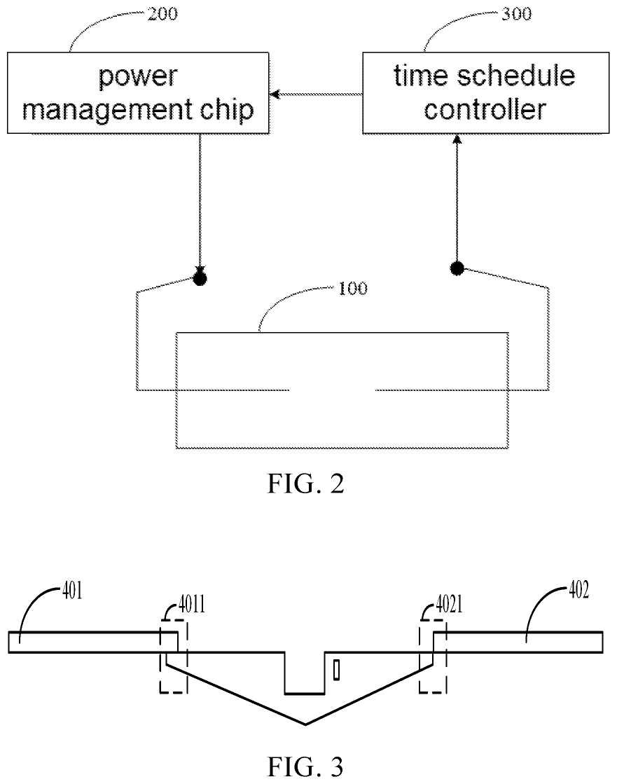

As illustrated in FIG. 1 and FIG. 2, the common electrode layer 10 is configured as N common electrode partitions 100 electrically isolated from each other. As illustrated in FIG. 1, wiring patterns of the common electrode partitions 100 in a same column in the common electrode layer 10 are same or similar. Wherein, a feedthrough wiring 101 of the first common electrode partition 100 and a feedthrough wiring 111 of the second common electrode partition 100 are equally spaced. The feedthrough wiring 111 of the second common electrode partition 100 and the feedthrough wiring 121 of the third common electrode partition 100 are equally spaced. A feedback wiring 102 of the first common electrode partition 100 and a feedback wiring 112 of the second common electrode partition 100 are equally spaced. The feedback wiring 112 of the second common electrode partition 100 and the feedback wiring 122 of the third common electrode partition 100 are equally spaced. The first common electrode partition 100, the second common electrode partition 100, and the third common electrode partition 100 are located on a same column and are three common electrode partitions 100 arranged sequentially in a column direction. The power management chip 200 is electrically connected to the common electrode partitions 100 and is configured to provide a feedthrough voltage to the common electrode partitions 100 according to a control signal. The time schedule controller 300 is electrically connected to the common electrode partitions 100 and the power management chip 200, and outputs a corresponding control signal in response to a feedback voltage of the common electrode partitions 100 being out of an offset range. Wherein, N is an integer greater than or equal to 2. For example, N can be but is not limited to be equal to 9.

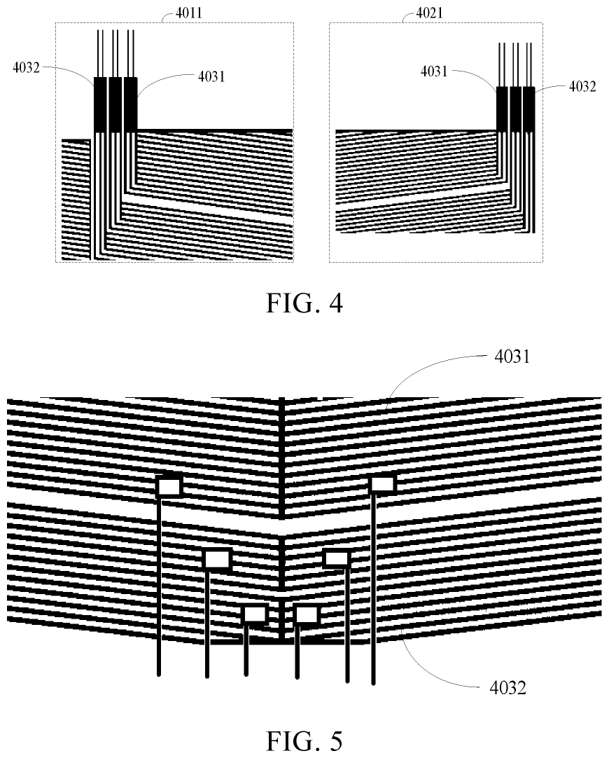

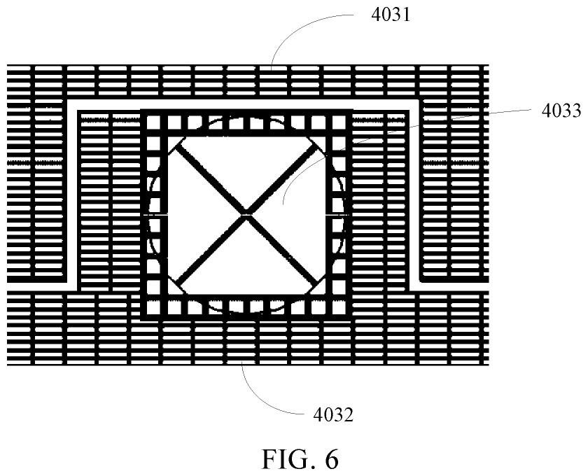

Specifically, as illustrated in FIG. 3, the feedthrough wiring 4031 and the feedback wiring 4032 are from the chip-on-film thin film disposed on the display panel 1100 to the first conductive layer disposed on the array substrate in this way. At first, the feedthrough wiring 4031 and the feedback wiring 4032 are guided out from a first chip-on-film thin film 401 and a second chip-on-film thin film 402. It should be noted that the wiring guided out from the first chip-on-film thin film 401 includes the feedthrough wiring 4031 and the feedback wiring 4032 which are electrically isolated. Wherein, as illustrated in FIG. 3 and FIG. 4, in a region 4011 where the first chip-on-film thin film 401 is connected to the feedthrough wiring 4031 and the feedback wiring 4032, and in a region 4021 where the second chip-on-film thin film 402 is connected to the feedthrough wiring 4031 and the feedback wiring 4032, the feedthrough wirings 4031 are both located on an inner side, the feedback wirings 4032 are located on a outer side, and they are electrically isolated to each other. The wirings guided out from the second chip-on-film thin film 402 can also include feedthrough wirings 4031 and feedback wirings 4032 electrically isolated to each other. Then, as illustrated in FIG. 5, by a manner of strapping or bridging, the wirings are routed to the first conductive layer, and the feedthrough wirings 4031 and the feedback wirings 4032 are routed to the second conductive layer at appropriate positions in the first conductive layer by the manner of strapping or bridging. Wherein, an insulation layer is disposed between the first conductive layer and the second conductive layer. Then, as illustrated in FIG. 6, the feedthrough wiring 4031 and the feedback wiring 4062 enter into the common electrode layer 10 from the second conductive layer through a transfer pad 4033 , i.e. the conductive gold particles in the sealant, so that they are routed to corresponding common electrode partitions 100. Wherein the feedthrough wiring 4031 is configured to transmit a feedthrough signal, and the feedback wiring 4032 is configured to transmit a feedback signal.

In one of the embodiments, the N common electrode partitions 100 electrically isolated from each other are distributed in a matrix manner. It should be noted that the matrix composed of these common electrode partitions 100 can be but is not limited to be a matrix with same numbers of rows and columns. For example, the number of the rows is 3, and the number of the columns is also 3. Of course, the matrix composed of these common electrode partitions 100 can be a matrix with unequal numbers of rows and columns. For example, the number of the rows is 3 and the number of the columns is 2, or the number of rows is 2 and the number of columns is 3.

Wherein, areas of the common electrode partitions 100 in at least one row or at least one column can be, but are not limited to be equal, and the common electrode partitions 100 in at least one row or at least one column can all be rectangular; or the areas can be different, or they can be square, or be circular, or also be elliptical, or be other irregular shapes, for example, five-pointed star shape, trapezoid shape, or a combination of the aforesaid shapes. A distance between two adjacent shapes can be minimized to eliminate region out of the common electrode partitions 100 where adjustment of feedthrough voltage is not allowed to perform.

Wherein, when the shape of the common electrode partitions 100 is rectangular, the common electrode partitions 100 have long edges and short edges. A direction of the long edges is a length direction, and a direction of the short edges is a width direction. A length direction of the display panel 1100 is the direction of its long edges, and a width direction of the display panel 1100 is a direction of its short edges, regardless whether the display panel 1100 must be an actual rectangle, even if it has rounded corners, similar estimation can be performed according to this herein. Therefore, the length direction of the common electrode partitions 100 is consistent with the length direction of the display panel 1100, and the width direction of the common electrode partitions 100 is consistent with the length direction of the display panel 1100.

In one of the embodiments, the time schedule controller 300 responds to a first offset value of the feedback voltage, and the power management chip 200 outputs the feedthrough voltage added by a second offset value, and wherein the first offset value and the second offset value are opposite to each other. For example, when the feedback voltage is increased by 0.6V, i.e., when the first offset value is 0.6V, at this time, the feedthrough voltage is reduced by 0.6V to ensure that the voltage in the common electrode partitions 100 is at an appropriate value, which facilitates to weaken or eliminate the image sticking and to improve display quality.

It should be noted that an offset range in this application can range from but is not limited to −150 mV to 150 mV, can also range from −150 mV to 120 mV, and can also range from −120 mV to 120 mV. It can be understood that when the offset range is not out of the range defined by the aforesaid data, the time schedule controller 300 does not adjust the feedthrough voltage by the power management chip 200. Only when the aforesaid data range is exceeded, the feedthrough voltage is adjusted.

It should be noted that the first chip-on-film thin film 401 and the second chip-on-film thin film 402 in the present application are close to a source driver chip. As a design of a whole-face form is adopted on the common electrode layer 10, and there are only one feedthrough voltage and one feedback voltage, three groups of data near to far from the source driver chip are obtained through simulation measurement. Each group of the data is voltage values of three test points in a same row, and its unit is volts. Wherein, a first group of the data are 1.9, 2.2, and 1.9 from left to right sequentially, a second group of the data are 2.1, 2.3, and 2.0 from left to right sequentially, and a third group of the data are 2.2, 2.1, and 2.2 from left to right sequentially. From this, it can be understood that in-plane voltage distribution of the common electrode layer 10 of the whole-face design is not uniform, which is also a main reason causing occurrence of image sticking of DC voltage.

On the basis of this, the aforesaid various embodiments are provided by the present application to solve this problem, and better in-plane voltage distribution is obtained, specifics are as follows.

During an initial power-on period T0, the first group of the data, the second group of the data, and the third group of the data from near to far from the source drive chip are also selected. Wherein, the first group of the data is 5.98, 5.88, and 6.18, the second group of the data is 6.13, 6.25, and 6.21, and the third group of the data is 6.16, 6.22, and 6.15. At this time, just notice difference (JND, the difference that can only be recognized by human eyes, which refers to a judgment standard of image sticking (IS) degree) does not exist in the display panel 1100. It can be understood that each of the aforesaid data can correspond to one common electrode partition 100.

After 24 hours of power-on, i.e., T24, the voltage of each common electrode partition 100 drifts, and the IS phenomenon deteriorates. At this time, the first group of the data becomes 6.1, 6.0, and 6.05, the second group of the data becomes 6.2, 6.32, and 6.28, and the third group of the data become 6.25, 6.3, and 6.23. Correspondingly, at this time, the JND levels brought by change of the first group of the data are level 2.3 of positive residual, level 2.8 of positive residual, and level 2.1 of inverse residual, and the JND levels brought by change of the second group of the data are level 0, level 2.6 of positive residual, and level 0, and the JND levels brought by change of the third group of the data are level 0, level 2.1 of positive residual, and level 2.0 of inverse residual. It should be explained that the higher the JND level is, the higher the degree of the positive residual or the inverse residual is, and the more serious the image sticking is.

In this situation, the time schedule controller 300 detects occurrence of the feedback voltage shifting and adjusts the feedthrough voltage. The specific adjustments are as follows.

The first group of the data is adjusted to be 6.01, 5.92, and 6.2, the second group of the data is adjusted to be 6.17, 6.28, and 6.25, and the third group of the data is adjusted to be 6.22, 6.25, and 6.2. Correspondingly, the JND levels brought by change of the first group of the data are level 0, level 1.9 of positive residual, and level 0; the JND levels brought by change of the second group of the data are level 0, level 0; and level 0, and the JND levels brought by change of the third group of the data are level 0, level 0, and level 0.

After 73 hours of power-on, i.e. T73, because the time schedule controller 300 continuously detects the feedback voltage of each common electrode partition 100 in real time, the voltage in each common electrode partition 100 is still at a better level at this time, and the IS performs well. The specifics are as follows.

The JND levels brought by change of the first group of the data are level 0,level 0, and level 0. The JND levels brought by change of the second group of the data are level 0, level 1.9 of the positive residual, and level 0. The JND levels brought by change of the third group of the data are level 0, level 1.8 of the positive residual, and level 0.

Particularly, when N is equal to 9, 9 regions are proportion of areas of 9 common electrode partitions 100, which are not uniformly distributed according to a size of a display region (activation areas, AA) certainly and can be configured in proportion according to simulation result of the actual voltage (feedthrough voltage) distribution and capacitance and resistor-capacitor (RC) loading. This is especially suitable for large-size panel design, such as 49-inch, 55-inch, 65-inch, 75-inch, 85-inch, 98-inch, 110-inch and other large-size or super-size of fields of panel design. The larger the size of the AAs are, the greater the difference of the voltage of common electrodes at different positions of the display panel is, and the better the improvement effect for IS by partition design/partition adjustment of the common electrode partitions 100 is.

In one of the embodiments, the present application provides a display panel 1100. A common electrode layer 10 is disposed in the display panel 1100. The common electrode layer 10 includes N common electrode partitions 100 electrically isolated from each other. The display panel 1100 outputs a corresponding feedthrough voltage to the common electrode partitions in response to a feedback voltage of the common electrode partitions 100 being out of an offset range.

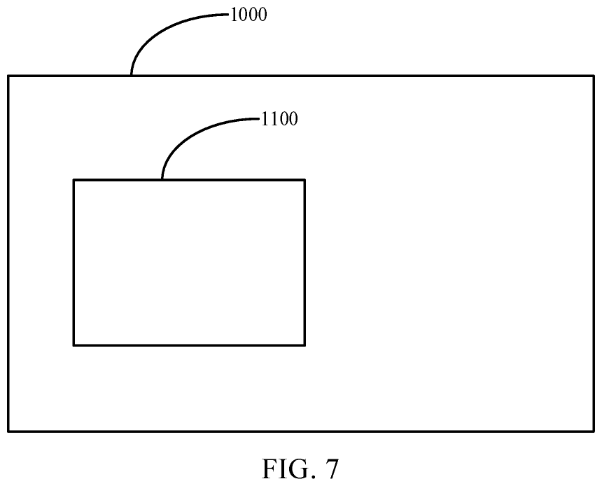

As illustrated in FIG. 7, in one of the embodiments, the present application provides a display device 1000 including the display panel of any aforesaid embodiment.

The display panel 1100 includes a color film substrate and an array substrate. The array substrate is aligned with the color film substrate to form a cell by sealant. Wherein, conductive gold particles are disposed in the sealant. The common electrode layer 10 is disposed on the color film substrate.

As illustrated in FIG. 1 and FIG. 2, the common electrode layer 10 can be configured as 3 common electrode partitions 100 electrically isolated from each other. As illustrated in FIG. 1, wiring patterns of the common electrode partitions 100 in a same column in the common electrode layer 10 are same or similar. Wherein, a feedthrough wiring 101 of the first common electrode partition 100 and a feedthrough wiring 111 of the second common electrode partition 100 are equally spaced. The feedthrough wiring 111 of the second common electrode partition 100 and the feedthrough wiring 121 of the third common electrode partition 100 are equally spaced. A feedback wiring 102 of the first common electrode partition 100 and a feedback wiring 112 of the second common electrode partition 100 are equally spaced. The feedback wiring 112 of the second common electrode partition 100 and the feedback wiring 122 of the third common electrode partition 100 are equally spaced. The first common electrode partition 100, the second common electrode partition 100, and the third common electrode partition 100 are located on a same column and are three common electrode partitions 100 arranged sequentially in a column direction. The power management chip 200 is electrically connected to the common electrode partitions 100 and is configured to provide a feedthrough voltage to the common electrode partitions 100 according to a control signal. The time schedule controller 300 is electrically connected to the common electrode partitions 100 and the power management chip 200, and outputs a corresponding control signal in response to a feedback voltage of the common electrode partitions 100 being out of an offset range.

Specifically, as illustrated in FIG. 3, the feedthrough wiring 4031 and the feedback wiring 4032 are from the chip-on-film thin film disposed on the display panel 1100 to the first conductive layer disposed on the array substrate. At first, the feedthrough wiring 4031 and the feedback wiring 4032 are guided out from a first chip-on-film thin film 401 and a second chip-on-film thin film 402. It should be noted that the wiring guided out from the first chip-on-film thin film 401 includes the feedthrough wiring 4031 and the feedback wiring 4032 electrically isolated. Wherein, as illustrated in FIG. 3 and FIG. 4, in a region 4011 where the first chip-on-film thin film 401 is connected to the feedthrough wiring 4031 and the feedback wiring 4032 and in a region 4021 where the second chip-on-film thin film 402 is connected to the feedthrough wiring 4031 and the feedback wiring 4032, the feedthrough wirings 4031 are both located on an inner side, the feedback wirings 4032 are located on a outer side, and they are electrically isolated to each other. The wirings guided out from the second chip-on-film thin film 402 can also include feedthrough wirings 4031 and feedback wirings 4032 electrically isolated to each other. Then, as illustrated in FIG. 5, by a manner of strapping or bridging, the wirings are routed to the first conductive layer, and the feedthrough wirings 4031 and the feedback wirings 4032 are routed to the second conductive layer at appropriate positions in the first conductive layer by the manner of strapping or bridging. Wherein, an insulation layer is disposed between the first conductive layer and the second conductive layer. And then, as illustrated in FIG. 6, the feedthrough wiring 4031 and the feedback wiring 4062 enter into the common electrode layer 10 from the second conductive layer through a transfer pad 4033 , i.e. the conductive gold particles in the sealant, so that they are routed to corresponding common electrode partitions 100. Wherein the feedthrough wiring 4031 is configured to transmit a feedthrough signal, and the feedback wiring 4032 is configured to transmit a feedback signal.

Specifically, the common electrode partitions 100 electrically isolated from each other can be but are not limited to be distributed in a matrix manner. It should be noted that the matrix composed of these common electrode partitions 100 can be but is not limited to be a matrix with same numbers of rows and columns. For example, the number of the rows is 3, and the number of the columns is also 3. Of course, the matrix composed of these common electrode partitions 100 can also be a matrix with unequal numbers of rows and columns. For example, the number of the rows is 3 and the number of the columns is 2, or the number of rows is 2 and the number of columns is 3.

Wherein, areas of the common electrode partitions 100 in at least one row or at least one column can be, but are not limited to be equal and the common electrode partitions 100 in at least one row or at least one column can all be rectangular; or the areas can be different, or they can be square, or be circular, or also be elliptical , or be other irregular shapes, for example, five-pointed star shape, trapezoid shape, or a combination of the aforesaid shapes. A distance between two adjacent shapes can be minimized to eliminate region out of the common electrode partitions 100 that performing adjustment of feedthrough voltage is not allowed to perform.

It should be noted that the display panel 1100 in the present application can be, but is not limited to be a liquid crystal panel. The liquid crystal panel includes a polarizing film, a glass substrate, a black matrix, a color filter sheet, a protective film, normal electrodes, a calibration layer, and a liquid crystal layer (liquid crystal, photospacers, sealant), capacitors, display electrodes, a prism layer, and a light scattering layer.

The polarizing film is also named as a polarizer. The polarizer is divided into an upper polarizer and a lower polarizer. Polarization functions of the upper polarizer and the lower polarizer are perpendicular to each other. Their functions are like a fence, which block light wave components according to requirement, for example, blocking the light wave components perpendicular to the polarizer fence, and only allows the light wave component parallel to the fence to pass through.

The glass substrate can be divided into an upper substrate and a lower substrate in the liquid crystal display, which main function is to clamp a liquid crystal material in a space between the two substrates. Alkali-free borosilicate glass with excellent mechanical properties, heat resistance and chemical corrosion resistance is generally adopted as a material of the glass substrate. For a thin film transistor liquid crystal display (TFT-LCD), TFTs are distributed on one layer of the glass substrate, and the color filter sheet is deposited on another layer of the glass substrate.

The black matrix is used to separate three primary colors of red, green and blue in the color filter sheet (preventing color mix) and prevents light leakage by contribution of a material of light-shielding performance, thereby facilitating to improve contrast of each color block. In addition, in the TFT-LCD, the black matrix can also shield electrode wirings or thin film transistors inside.

The color filter sheet is also named as a color filter film, which function is to generate three primary color lights of red, green, and blue to realize full-color display of the liquid crystal display.

An alignment layer is also known as an alignment film or an orienteering layer, which function allows the liquid crystal molecules to achieve uniform arrangement and orientation under microscopic level.

Transparent electrodes are divided into common electrodes and pixel electrodes. A voltage of an inputted signal is applied between the pixel electrodes and the common electrodes. The transparent electrode is usually formed by depositing an indium tin oxide (ITO) material on the glass substrate to form a transparent conductive layer.

The liquid crystal material serves a function similar to an optical shutter in the LCD, which can control brightness and darkness of transmitted light, so that an effect of information display is obtained.

A driver integrated circuit (IC) is actually a set of integrated circuit chip devices, used to adjust and control a phase, a peak value, a frequency, etc. of a potential signal on the transparent electrode to establish a driving electric field, and finally realizes the information display of the liquid crystal.

In the liquid crystal panel, an active matrix liquid crystal display is composed of a twisted nematic (TN) liquid crystal material enclosed between two glass substrates. Wherein, an upper glass substrate close to the display screen is deposited with color filter sheets (or color filter layers) of three colors of red, green, and blue (RGB), a black matrix, and a common transparent electrode. Thin film transistor (TFT) devices, transparent pixel electrodes, storage capacitors, gate lines, signal lines, etc., are mounted on a lower glass substrate (the substrate farther from the display screen). An alignment film (or an alignment layer) is manufactured on inner sides of the two glass substrates to align the liquid crystal molecules. The liquid crystal material is filled between the two glass substrates, and spacers are distributed to ensure uniformity of a gap. Surroundings are bonded by frame sealing glue to serve a sealing effect. The common electrodes of the upper glass substrate and the lower glass substrate are connected by a silver glue process.

Polarizers (or polarized films) are attached on outer sides of the upper glass substrate and the lower glass substrate respectively. When a voltage is applied between the pixel transparent electrode and the common transparent electrode, an arrangement state of the liquid crystal molecules is changed. At this time, intensity of incident light passing through the liquid crystal also changes accordingly. The information display is realized in the liquid crystal display on the basis of optical rotation of the liquid crystal material and coordinated with control of the electric field.

LCD products are non-active light-emitting electric devices and do not have luminous characteristics. They must rely on emission of light sources in backlight modules to obtain display performance. Therefore, brightness of the LCDs is determined by their backlight modules. It can be understood that the performance of the backlight modules directly affects display quality of the LCD panels.

The backlight module includes an illumination source, a reflector sheet, a light guide plate, a diffusion sheet, a brightness enhancement film (prism sheet) and a frame, etc. The backlight modules adopted in LCDs can be mainly divided into two categories of edge-lit backlight modules and direct-lit backlight modules. The edge-lit backlight modules are mainly adopted in mobile phones, laptops and monitors (15 inches), while direct-type backlight modules are mostly adopted in LCD televisions. Regarding the backlight module light sources, cold cathode fluorescent lamps (CCFLs) or light emitting diode (LED) light sources mainly act as backlight sources of LCDs.

Reflector sheets are also named as reflector masks. Their main function is to completely reflect light emitted from light sources to the light guide plate, and reduce unnecessary loss as much as possible.

The main function of the light guide plate is to guide the light emitted by a lateral light source to front of the panel.

The prism film is also named as brightness enhancement film, a main function of which is to refract and totally reflect every scattered light through the film layer, and concentrates the light at a certain angle, and then emits the light from the backlight source to serve a screen brightening display effect.

A main function of the diffuser is to correct an edge-lit light of the backlight module into an uniform surface light source to achieve an effect of optical diffusion. The diffuser is divided into an upper diffuser and a lower diffuser. The upper diffuser is located between the prism sheet and liquid crystal assemblies and is close to the display panel, while the lower diffuser is located between the light guide plate and the prism sheet and is close to the backlight source.

LCD is a display that liquid crystal is adopted as a material. The liquid crystal is a type of an organic compound between solid and liquid. Under room temperature conditions, the liquid crystal presents both liquid fluidity and optical anisotropy of crystals. It can become a transparent liquid when heated, and can become crystallized turbid solid after cooling.

Under an effect of an electric field, arrangement of the liquid crystal molecules is changed, thereby affecting intensity of incident light penetrating through the liquid crystal. This change in light intensity is further presented as a change of brightness and darkness by an effect of the polarizer. Accordingly, by controlling the electric field of the liquid crystal, change of brightness and darkness of the light can be realized, so that the purpose of information display is achieved. Therefore, the liquid crystal material is similar to a small optical shutter.

As there are control circuits and driver circuits around the liquid crystal material, when electrodes in the LCD generate an electric field, the liquid crystal molecules are twisted. Therefore, light passing through the LCD is regularly refracted (optical rotation of the liquid crystal material), and then is filtered by a second polarizer to display on the screen.

It is worth to mention that because the liquid crystal material itself does not emit light, the LCDs usually need to be equipped with additional light sources for display panels. A main light source system is named as backlight module. Wherein, backlight plates are composed of fluorescent materials that can emit light, which main function is to provide uniform backlight sources.

LCD technology is to fill the liquid crystal between two planes with narrow grooves. The grooves on these two planes are perpendicular to each other (intersect at 90 degrees). In other words, if molecules on one plane are aligned north-south, the molecules on another plane are aligned east-west, while the molecules between the two planes are forced into a 90-degree twisted state. Because the light propagates along the direction of the arrangement of the molecules, the light is also twisted 90 degrees when passing through the liquid crystal. When a voltage is applied to the liquid crystal, the liquid crystal molecules can rotate to change a light transmittance rate, thereby realizing multi-gray scale display.

LCDs are usually composed of two polarizers perpendicular to each other. The polarizers act like fences, which block light wave components according to requirement, for example, blocking the light wave components perpendicular to the polarizer fence, and only allows the light wave component parallel to the fence to pass through. Environmental light diverges randomly in all directions. The two polarizers perpendicular to each other should block all the environmental light that attempts to penetrate under normal situation. However, because the two polarizers are filled with twisted liquid crystals, after the light penetrates the first polarizer, it will be twisted by the liquid crystal molecules at 90 degrees, and finally penetrates the second polarizer.

Regarding LCDs of laptops or desktop, more complicated color displays are required.

Regarding color LCDs, color filter layers that specializes in processing color display are also needed, i.e., the so-called “color filter”, also known as “color filter film”. In color LCD panels, each pixel is usually composed of 3 liquid crystal cells. Wherein, there are three-color filters of red, green, or blue (RGB) in front of each of the unit cells respectively. In this way, lights passing through different unit cells can display different colors on the screen.

Color filters, black matrices, and common transparent electrodes are generally deposited on front glass substrates of the display screens. Color LCDs can create colorful images in high-resolution environments.

Human visual organs (eyes) perceive dynamic images with a phenomenon of so-called persistence of vision, i.e., high-speed moving images can form a short-term impression in human brains. In early cartoons, movies, and even in the latest game shows, because the principle of persistence of vision is used, a series of gradual changing images to displayed in rapid succession in front of human eyes is allowed, and dynamic images are formed.

When the plurality of images are generated at a speed exceeding 24 frames/sec, the human eyes can perceive continuous images. This is also an origin of a movie playback speed of 24 frames per second. If the display speed is lower than this standard, people can obviously feel pause and discomfort of the images. Calculated according to this index, the display time of each image needs to be less than 40 ms. Regarding high-definition display of fast moving images, general image motion speed exceeds 60 frames/sec. In other words, an interval time of each frame of the dynamic images is 16.67 ms.

If a response time of the liquid crystal is longer than the interval time of each frame of the images, people can feel the screen being slightly fuzzy when watching fast-moving images. Response time is a special index of LCDs. The response time of LCDs refers to a speed at which each pixel of the display reacts to an input signal, i.e., the response time of the liquid crystal from “dark to bright” or from “bright to dark”. This value is as small as possible, and a sufficiently fast response time can ensure continuity of the screen. If the response time is too long, it is possible to allow a sense of trailing shadows on the LCDs when dynamic images are displayed. Generally, the response time of LCDs ranges from 2 ms to 5 ms.

The so-called TFT refers to a transistor array on a glass substrate of a liquid crystal panel, so that each pixel of the LCD is equipped with its own semiconductor switch. Each pixel can control the liquid crystal between the two glass substrates through point pulses, i.e., controlling each pixel independently, precisely, and point-to-point is realized by an active switch. Therefore, each node of the pixel is relatively independent and can be continuously controlled.

TFT-LCDs are mainly composed of glass substrates, gate electrodes, drain electrodes, source electrodes, semiconductor active layer (amorphous silicon, a-Si), etc.

TFT arrays are generally deposited together with transparent pixel electrodes, storage capacitors, gate electrode lines, signal lines, etc., on rear glass substrates of the display screens (substrates farther from the display screens). The configuration of such the transistor array facilitate to improving the response speed of the LCD screens, and can also control display gray levels, thereby ensuring image colors of the LCDs to be more realistic and picture quality to be more pleasing to the eye. Therefore, most LCDs, LCD televisions, and some mobile phones are driven by TFTs. Whether they are liquid crystal televisions (LCD-TVs) of small and medium-sized LCDs with a narrow viewing angle twisted nematic (TN) mode or large-size LCDs with a wide viewing in-plane switching (IPS) mode, they are generally named as TFT-LCDs.

It can be understood, that for those of ordinary skill in the art, various other corresponding changes and modifications can be made according to the technical solutions and technical ideas of the present application, and all such changes and modifications are intended to fall within the scope of protection of the claims of the present application.

What is claimed is:

1. A display panel, comprising:
a common electrode layer, wherein the common electrode layer is configured as N common electrode partitions electrically isolated from each other;
a power management chip electrically connected to the common electrode partitions and configured to provide a feedthrough voltage to the common electrode partitions according to a control signal; and
a time schedule controller electrically connected to the common electrode partitions and the power management chip and outputting a corresponding control signal in response to a feedback voltage of the common electrode partitions being out of an offset range,
wherein N is an integer greater than or equal to 2.

2. The display panel as claimed in claim 1, wherein the N common electrode partitions electrically isolated from each other are distributed in a matrix manner.

3. The display panel as claimed in claim 2, wherein at least one row or at least one column of the common electrode partitions have same areas and are rectangular.

4. The display panel as claimed in claim 3, wherein a length direction of the common electrode partitions is consistent with a width direction of the display panel, and a width direction of the common electrode partitions is consistent with a length direction of the display panel.

5. The display panel as claimed in claim 1, wherein the display panel comprises a color film substrate, and the common electrode layer is disposed on the color film substrate.

6. The display panel as claimed in claim 5, wherein the display panel comprises an array substrate, and the array substrate is aligned with the color film substrate to form a cell by sealant, and wherein conductive gold particles are disposed in the sealant.

7. The display panel as claimed in claim 6, wherein the display panel comprises a chip-on-film thin film and a first conductive layer disposed on the array substrate,
a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.

8. A display panel, wherein a common electrode layer is disposed in the display panel, the common electrode layer comprises N common electrode partitions electrically isolated from each other, the display panel outputs a corresponding feedthrough voltage to the common electrode partitions in response to a feedback voltage of the common electrode partitions being out of an offset range, and
wherein the common electrode partitions are circular or elliptical.

9. The display panel as claimed in claim 8, wherein the display panel comprises a color film substrate, and the common electrode layer is disposed on the color film substrate.

10. The display panel as claimed in claim 9, wherein the display panel comprises an array substrate, and the array substrate is aligned with the color film substrate to form a cell by sealant, and wherein conductive gold particles are disposed in the sealant.

11. The display panel as claimed in claim 10, wherein the display panel comprises a chip-on-film thin film and a first conductive layer disposed on the array substrate, a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.

12. The display panel as claimed in claim 8, wherein the offset range ranges from −150 mv to 150 mv.

13. The display panel as claimed in claim 12, wherein the offset range ranges from −120 mv to 120 mv.

14. A display device, comprising the display panel as claimed in claim 1, wherein the time schedule controller responds to a first offset value of the feedback voltage, the power management chip outputs the feedthrough voltage added by a second offset value, and wherein the first offset value and the second offset value are opposite to each other.

15. The display device as claimed in claim 14, wherein the N common electrode partitions electrically isolated from each other are distributed in a matrix manner.

16. The display device as claimed in claim 15, wherein at least one row or at least one column of the common electrode partitions have same areas and are rectangular.

17. The display device as claimed in claim 16, wherein a length direction of the common electrode partitions is consistent with a width direction of the display panel, and a width direction of the common electrode partitions is consistent with a length direction of the display panel.

18. The display device as claimed in claim 14, wherein the display panel comprises a color film substrate, and the common electrode layer is disposed on the color film substrate.

19. The display device as claimed in claim 18, wherein the display panel comprises an array substrate, and the array substrate is aligned with the color film substrate to form a cell by sealant, and wherein conductive gold particles are disposed in the sealant.

20. The display device as claimed in claim 19, wherein the display panel comprises a chip-on-film thin film and a first conductive layer disposed on the array substrate, a feedthrough wiring and a feedback wiring connected to the chip-on-film thin film are disposed in the first conductive layer, and wherein the feedthrough wiring is configured to transmit a feedthrough signal, and the feedback wiring is configured to transmit a feedback signal.
